(19) United States
(12) Patent Application Publication
(10) Pub. No.: US 2006/0059669 A1
(43) Pub. Date: Mar. 23, 2006

(54) Vessel for memorializing cremated pet

(76) Inventor: Victoria Rose, Salem, OR (US)

Correspondence Address: Ms. Victoria Rose, PO Box 4711, Salem, OR, 97302, US

(21) Appl. No.: 10/950,544

(22) Filed: Sep. 23, 2004

(51) Int. Cl. A61G 17/00

(52) U.S. Cl. 27/1

(57) ABSTRACT

A depository vessel for the display and memorializing of a deceased pet and of the type having an outer (1,2) and inner (7) lining of the pet owner's choice. The closure (5) will be such that the cremated remains of the pet (9) may be placed inside the vessel and held securely inside. The outer design of the vessel is meant to replicate the deceased pet by displaying memorabilia and pictures that bring to mind the presence of the pet. This vessel will provide cushioned and interactive tactile comfort to a grieving pet owner, through a design unique among existing cremation depository vessels.

### BACKGROUND OF THE INVENTION

1. Field of Invention

This invention relates generally to the death care industry, and more particularly to storage for and methods of memorializing a deceased, cremated pet.

2. Discussion of Prior Art

There are many products in prior art with the purpose of containing the cremated remains of a cherished pet, and even some that display the remains in a creative and satisfyingly memorializing method. However, there continues to be small variety of choices in the area of personalization in the pet death care industry.

Additionally, there is a lack of products evident in the prior art that memorializes a pet in a means that addresses the anguish and need for physically tangible comfort to which a pet-owner is subject when faced with a loss. Much of the prior art consists of a means to display cremated remains in a decorative fashion, on a mantelpiece or hung on the wall.

Accordingly, there are two different classes of patents concerning memorializing products involving cremated remains: containment methodology and means by which the ashes may be molded into a memorializing display item.

In addition to the traditional urns, there are several containment methodologies listed in the prior art. U.S. Pat. No. 6,735,831 to Greiwe, et al, describes a receptacle and a memorial plaque which one may put on display along with a tray for mementos, while U.S. Pat. No. 6,175,995 to Parker, et al describes a lawn or garden ornament with a compartment adapted to contain the cremated remains. Other display devices include a football-helmet shaped crematory urn (U.S. Pat. No. 5,896,632), candlestick holder/crematory remains container (U.S. Pat. No. 5,813,098), cube-shaped vessel for cremated remains having a receptacle for a photograph (U.S. Pat. No. 6,526,636) and a pyramid shaped display device (U.S. Pat. No. 5,704,103). All of these patents provide a way to contain the remains in an attractive and unique way, but does not provide any further comfort to the grieving than can be provided by sight alone.

Molding methodology takes the memorializing field a step farther. These products allow loved ones to incorporate the cremated ashes into a moldable substance which can then be shaped in a likeness of the one who is lost, or in some other shape particular to the loved ones' interests. In U.S. Pat. No. 5,016,330, Botsch describes this very process and that the resulting surface may be inscribed with indicia descriptive of the identity of the being who is the source of the ash. U.S. Pat. No. 6,200,507 to Dennis describes a means of combining crematory ash with a resin which may be cured into any shape and finished with an outer layer material such as marble, bronze or wood. Santorello, et al, describes an ash silhouette display case in U.S. Pat. No. 6,665,916, in which the ashes are poured into a mold taking the shape of the deceased. These methods are ways in which the crematory ashes may actually be visualized by loved ones. They still provide no tactilely satisfying comfort to the grieving pet owner, however.

Memorializing products heretofore known suffer from some key disadvantages:
a. Personalization options are limited by the design of the items that have been mentioned. They can be inscribed with unique messages or made into unique shapes, but there are a limited number of ways to personalize a wooden box or ashen statue.
b. They do not offer a physically and tactilely comforting memorializing experience for the grieving loved one. There is no means for display of cremated remains that gives the handler a cushioned tactile sensation, while providing an aesthetically pleasing and appropriately memorializing appearance.

3. Objects and Advantages

Accordingly, several objects and advantages of the present invention are:
a. to provide a depository for cremated remains that uniquely displays some facet(s) of the pet's life, such as favorite toys or people, or characteristic image of the pet.
b. to provide pet owners with the freedom to choose any suitable fabric for the display surface of the item that they consider appropriate to memorialize their pet. In this way the product may be highly personalized, such as by including text, graphics and memorabilia relating to the life of the deceased animal.
c. to provide tangible comfort to grieving pet owners after the loss of their beloved pet; having practical uses beyond those of traditional cremation depository vessels.
d. to provide a decorative, memorializing item that may be constructed of a variety of materials, sizes and closure methods.
e. to provide a memorializing item having the discreet characteristic of being a cremated remains depository vessel (this characteristic may be kept secret by the owner).
f. to provide an item that is durable and that maintains its desired appearance for extended periods of time.

Further objects and advantages of the invention will become apparent from a consideration of the drawings and ensuing description.

### SUMMARY

In accordance with the present invention, the vessel will be comprised of a display method to discreetly hold cremated remains of animals in a decorative and artistic fashion. In the preferred mode, the remains are enclosed within a soft inner cavity. The soft outer fabric covering, is suitable for providing alleviation of stress to the grieving. Viewed in its entirety, the vessel resembles a small pillow in look and feel. The design of the cover may be of any material or image specified, and may display other physical memorabilia, giving the item a “personalized” effect. The material may also display any colors or graphics, text, or images of items or scenes related to the life of the deceased pet. The method results in an artistic, aesthetically pleasing and physically comforting reminder of a cherished pet.

### DRAWINGS

Figures:

FIG. 1 shows an anterior view of the vessel.

FIG. 2 shows a posterior view of the vessel.

FIG. 3 shows a lateral profile view of the vessel.

FIG. 4 shows a peeled away view of the vessel.

FIG. 5 shows a cross-sectional view (analogous to lateral profile) of the vessel.

FIG. 6 shows alternative closure method: zipper

FIG. 7 shows alternative closure method: hook and loop fastener

FIG. 8 shows alternative closure method: snaps

FIG. 9 shows alternative closure method: buttons

FIG. 10 shows alternative overall vessel shape: heart

FIG. 11 shows alternative overall vessel shape: disc

### LIST OF REFERENCE NUMERALS

1. anterior lining
2. posterior lining
3. side-seam
4. seam binding
5. closure
6. closure flap
7. interior lining
8. filling material
9. cremated remains (contained in sealed bag)
10. cavity to contain remains
11. zipper
12. hook and loop fastener
13. snaps
14. buttons
15. button-holes

### DETAILED DESCRIPTION

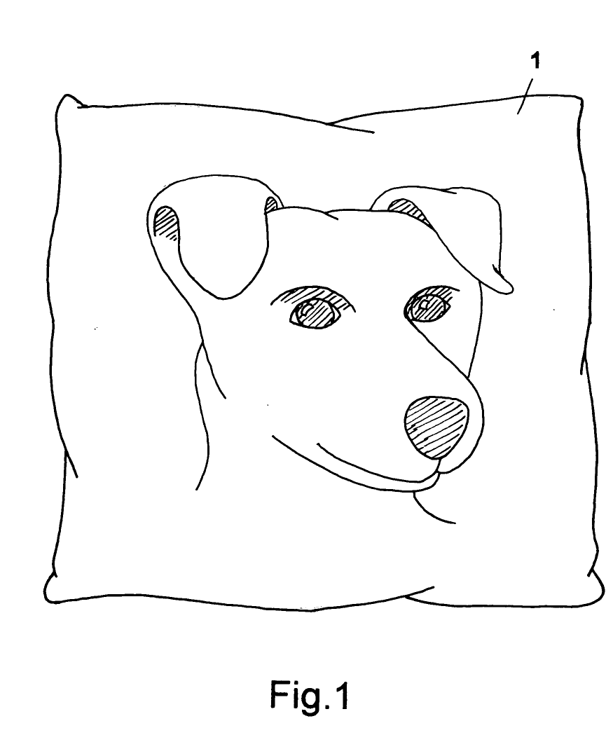

Preferred Embodiment (FIG. 1-5)

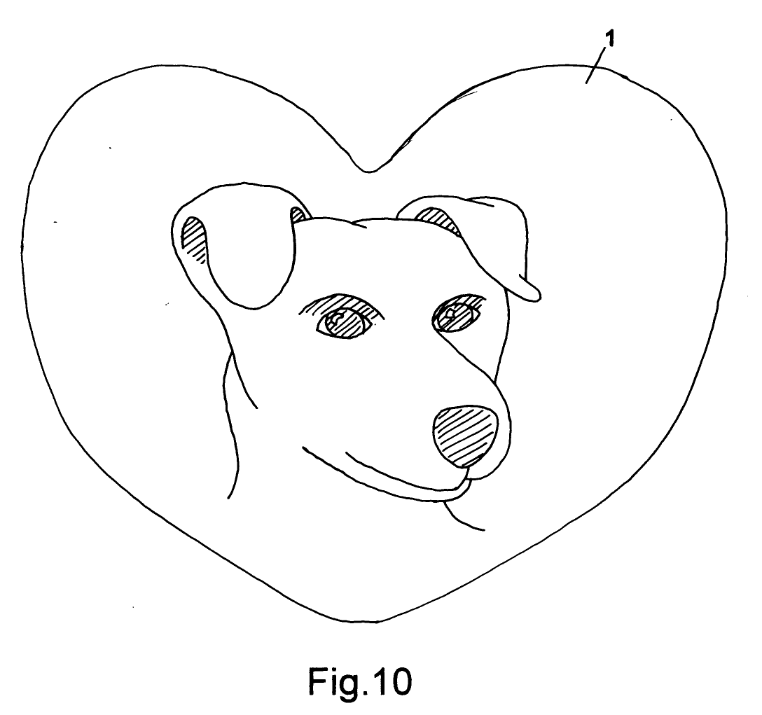

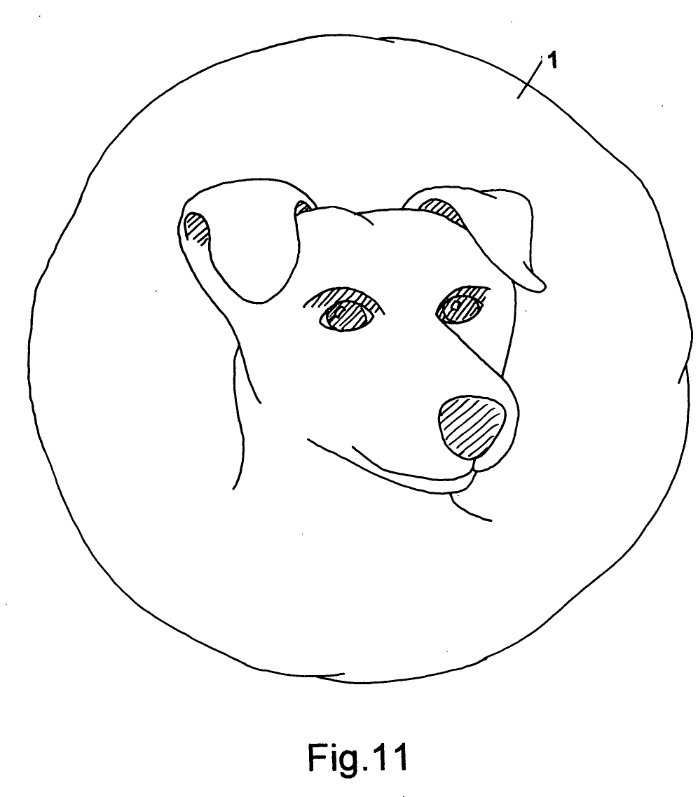

FIG. 1 shows the intention of the material covering of the anterior of the item 1 may consist of any suitable material, including material depicting pictures or text pertaining to the cremated remains within the vessel, or material which matches the pet owner's home decor. This material and the displays thereon may be comprised of any material that may be stitched at the side-seams 3. In the preferred embodiment, the size of the rectangular vessel is 13 inches×13 inches×3 inches. In alternative embodiments, the vessel may be made in any simple shape while retaining the core design characteristics (see description of additional embodiments, FIG. 10-11).

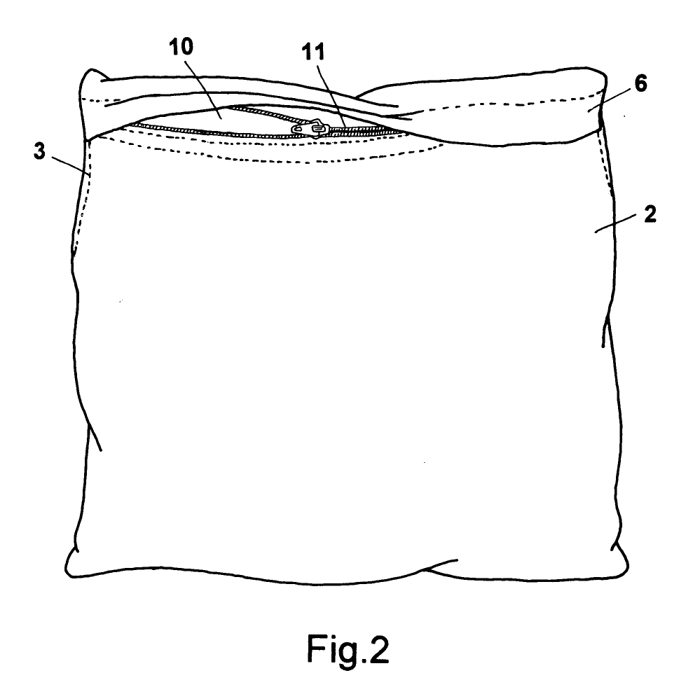

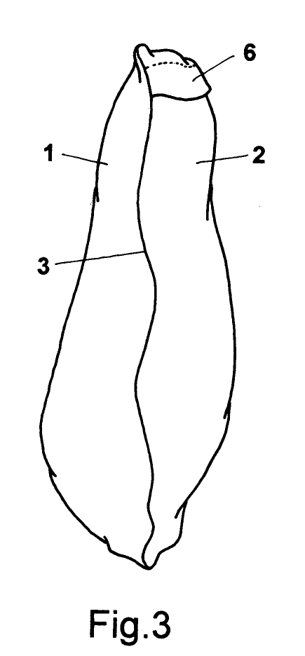

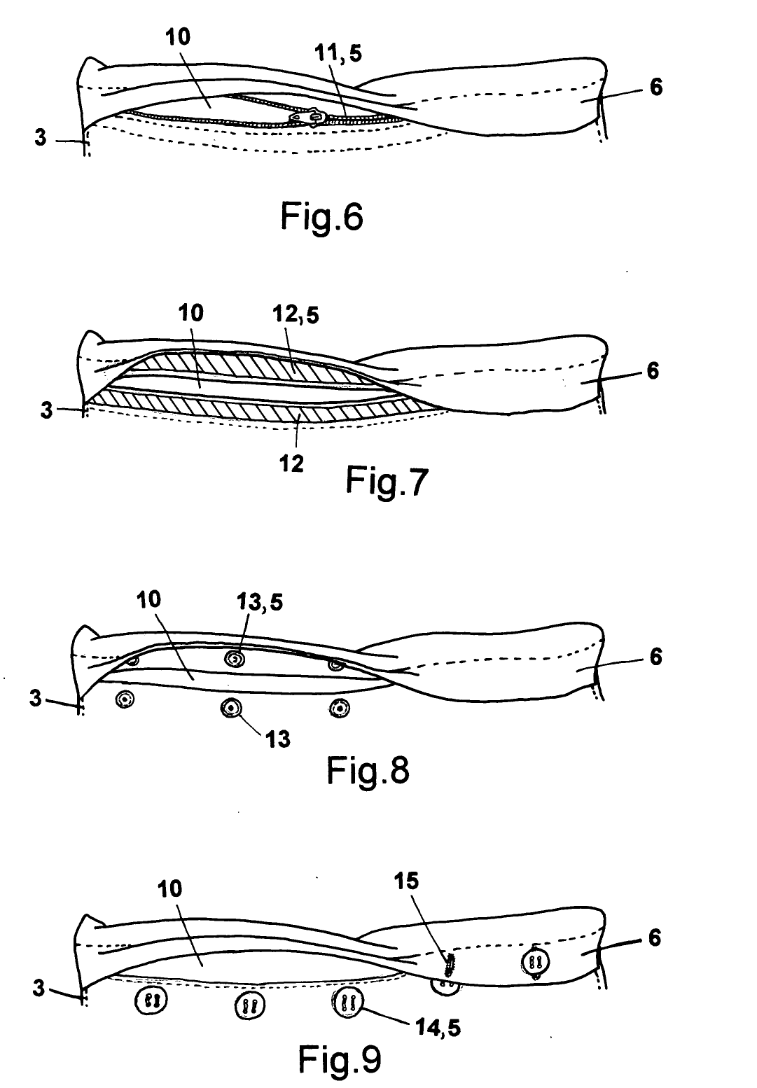

FIG. 2 depicts the posterior view of the vessel. The material covering of the back piece 2 may also be made of any material suitable for stitching at the side-seams 3. The rear view also shows the closure 5, which runs along an entire side of the rectangular-shaped vessel. In the preferred embodiment in FIG. 2 and 3, this closure is placed an inch from the top edge of the vessel, creating a closure flap 6. In the preferred embodiment, the closure 5 is a zipper. However, this feature may be comprised of any mechanism the manufacturer deems suitable, and can be specified by the end user (see description of additional embodiments, FIG. 6-9).

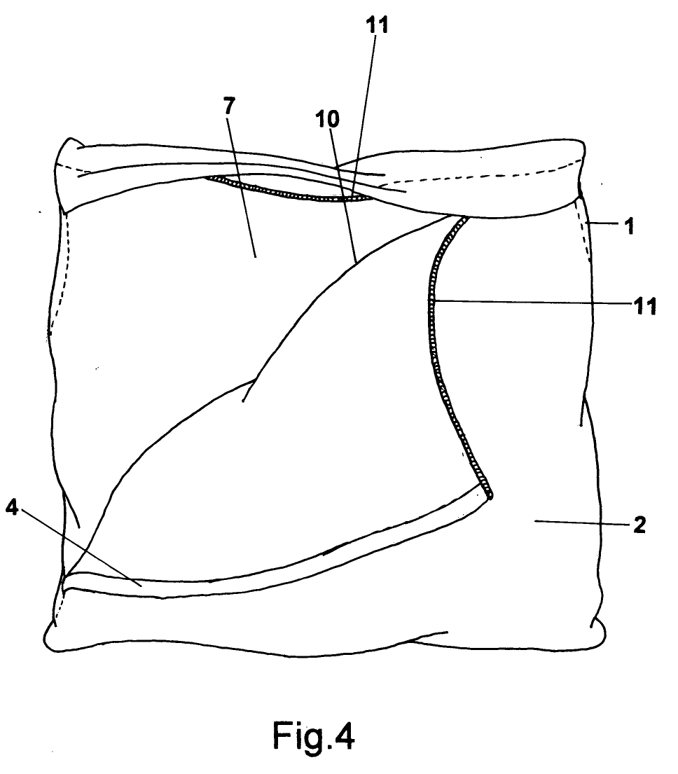

FIG. 4 shows a peeled away view of the vessel exposing the inside cavity 10. Interior lining 7 of the cavity may be specified by the end user and may be any material suitable for stitching, similar to the front and back exterior linings 1,2. In the preferred embodiment, the interior lining 7 is a slick or soft feeling fabric, such as satin or flannel, reminiscent of the inside lining of a casket. Inside seams attaching the anterior and posterior sides of the vessel are covered with seam binding 4 for a more finished look.

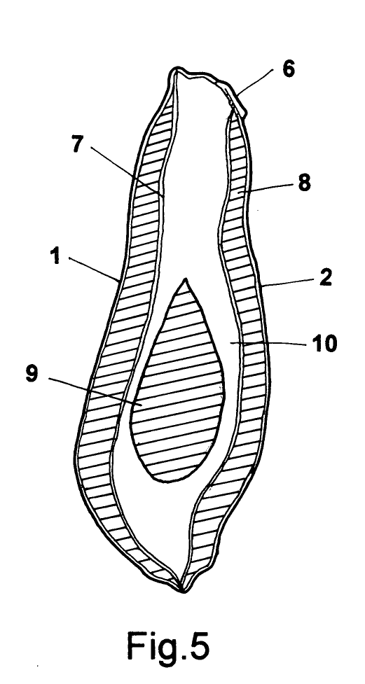

FIG. 5 depicts a cross-sectional view of the vessel. Here the fiber filling 8 is evident between the exterior lining pieces 1,2 and the interior lining 7. In the preferred embodiment, the fiber filling 8 consists of polyester blend or cotton batting (8 oz weight). Inside the cavity 10 lies the cremated remains of the pet 9 sealed in a container provided by the mortuary, and placed in the vessel by the end user.

Operation of Invention (FIG. 1-5)

The design of the vessel is oriented toward giving any handler of the vessel a cushioned tactile sensation, while providing an aesthetically pleasing and appropriately memorializing appearance. The appearance, to be specified by the end user, is evident in the anterior and posterior linings 1,2. The operation of the vessel consists of the action of placing the cremated remains 9 inside the cavity 10. This can be performed by opening the closure 5 beneath the closure flap 6, placing the sealed remains 9 inside, and re-closing the closure 5. The vessel can then be used in any physically comforting way to a grieving pet owner. Examples of these uses are (but not limited to) displaying the vessel on a bed or couch where the pet was known to sleep, holding the vessel in a way that brings to mind the presence of the deceased, or attaching locks of the pet's hair, ribbons or barrettes to the vessel. The side-seams 3, interior lining 7, and fiber filling 8 exist to support the conceptual design of the vessel and contribute to the cushioned effect that is so comforting to a grieving pet owner.

Additional Embodiments (FIG. 6-12):

Additional embodiments in FIG. 6-9 consist of alternative closure methods. FIG. 6 depicts the preferred embodiment of a zipper closure 11. FIG. 7 shows a hook and loop fastener closure 12, the hook piece attached to the closure flap 6 and the loop piece attached to the posterior lining 2. FIG. 8 shows closure being made with a series of snaps 13, the male side of the snap attached to the closure flap 6 and the female piece attached to the posterior lining 2. FIG. 9 shows closure with buttons 14 and button-holes 15. Alternative closure does not affect the overall operation of the item, only the method of entry and exit to the cavity 10. FIG. 6-9 do not exhaust the supply of additional embodiments of closure methods, and serve only as examples contemplated by the applicant.

Additional Embodiments in FIGS. 10-11 are examples of alternative overall vessel shapes. These shapes would require more complex manufacturing processes than the preferred embodiment. FIG. 10 shows a heart shaped vessel, and FIG. 11 shows a disc or circular shaped vessel. All alternatively shaped vessels are endowed with the same basic characteristics (1-10) as the preferred embodiment in similar locations on the vessel, and have the same additional closure embodiments as well. Alternative shape does not affect the operation of the item. FIGS. 10-11 do not exhaust the supply of additional embodiments of overall vessel shapes and serve only as examples contemplated by the applicant.

Advantages

From the description above, a number of advantages of the vessel are evident:
a. the vessel provides an elegant, discreet and highly personalized means of displaying the cremated remains of a beloved pet
b. it provides tactile comfort in a time of grief
c. it provides a simple means of opening and closing the cavity containing the cremation remains
d. it is durable and would retain its shape and appearance for extended periods of time
   Conclusion, Ramifications and Scope

Thus, the reader will see that the vessel previously described gives the handler a cushioned tactile sensation, similar to that of a pillow or doll, while providing an aesthetically pleasing and appropriately memorializing appearance. This design provides a greater amount of comfort to some pet owners suffering a loss than would a traditional urn or burial container because of the orientation toward physical sensation exceeding that of sight. Furthermore, the vessel has additional advantages in that:
a. It permits the pet owner to choose the specific aesthetic qualities and features of the final resting place for their beloved pet; including color, specific material, pictures or text, and overall shape.
b. It provides a variety of closure options to secure the cremated remains in an attractive and safe containment field.
c. It provides tangible comfort to grieving pet owners after the loss of their beloved pet.
d. It provides an item that is durable and that maintains its desired appearance for extended periods of time.

While the above description contains specificities, these should not be construed as limitations on the scope of the invention, but rather as an exemplification of a few preferred embodiments thereof Many other variations are possible, limited only by the imagination of the manufacturer and the end user. For example, the vessel could have an overall appearance in the shape of a dog or cat (or whatever pet is desired), or some particular symbol with some significance to the pet owner. The outer covering of the vessel could have some distinguishing characteristics such as tassels or fringes that contribute significantly to the aesthetic design of the item. The dimensions of the embodiment could be specified to be very large, or very small, only limited by the volume of the cavity required to contain the cremated remains. It is also possible for the closure to consist of some different technology than that described here.

Accordingly, the scope of the invention should be determined not by the embodiments illustrated, but by the appended claims and their legal equivalents.

I claim:

1. A vessel for memorializing a cremated pet, comprising:

2. A contiguous anterior and posterior fabric lining having means for attachment on all edges by side-seams,

3. a contiguous lining interior to said fabric linings having means for attachment to said fabric linings by side-seams,

4. a filling material sandwiched by said anterior and posterior fabric linings and said interior fabric lining, and

5. a means for closure on the posterior side of said vessel for deposit of package containing cremated remains,

6. whereby grieving pet owners may be comforted by an aesthetically and tactilely pleasing and appropriately memorializing vessel for cremated remains.
